(19) United States
(12) Patent Application Publication
(10) Pub. No.: US 2025/0092650 A1
(43) Pub. Date: Mar. 20, 2025

(54) SHOWERHEADS WITH WATER FILTER AND SKIN TREATMENT ELEMENT

(71) Applicant: FilterBaby LLC, Gaithersburg, MD (US)

(72) Inventors: Xin Ma, Gaithersburg, MD (US); Aaron Saxton, Gaithersburg, MD (US); Matthew Saxton, Gaithersburg, MD (US)

(21) Appl. No.: 18/467,679

(22) Filed: Sep. 14, 2023

(51) Int. Cl. E03C 1/04; B05B 1/18; B05B 15/40; B05B 15/62

(52) U.S. Cl. CPC E03C 1/0408; B05B 1/185; B05B 15/40; B05B 15/62; E03C 2201/40

(57) ABSTRACT

A showerhead assembly may include a base member configured to be fluidly connected to a shower pipe, and defining a cavity in which a water filter is disposed. Magnet(s) may be positioned at a front wall opposite a wall that is proximate the shower pipe. A handheld showerhead may be fluidly connected to the base member. The handheld showerhead may include (i) a rear wall and (ii) a front face. Second magnet(s) may be positioned and arranged to be attracted to the first magnet(s). The handheld showerhead may be altered from a first elevation angle to a second elevation angle while magnetically retained by the base member.

### BACKGROUND

Showers are important for personal hygiene. Personal hygiene provides a variety of health and mental benefits for people. In some cases, warm or hot showers can offer pain relief by reducing inflammation, increasing blood flow, improving concentration, lessening fatigue, and making it easier to breathe, among other physical and mental benefits. Showering, of course, helps reduce bacteria on skin along with removing dead skin cells. Showering is also a social norm in most countries such that most people shower daily.

As society and technology has evolved, unfortunately the amount of pollutants that are in residential, commercial, and especially military water supplies, including those that are filtered by water treatment facilities, has grown significantly. Pollutants that are often found in water include harmful germs and chemicals as a result of fertilizers, pesticides, or other chemicals that have been applied to land near water sources (e.g., lakes, rivers, ground water, and reservoirs). In a shower, the water and steam from the heated water contacts the skin and is breathed in by the person showering. Different regions of the country and world have different pollutants, which may also shift throughout the year due to farming practices, rain events, melting snow, and so on.

Moreover, a recent study by the U.S. Geological Survey found that almost half of the tap water in the US is contaminated with chemicals known as “forever chemicals,” and this number may be lower than actual contamination because the tests were limited to only a small subset of 32 compounds of the total number of more than 12,000 of “forever chemicals” that are considered dangerous to human health. Forever chemicals are generally per-and polyfluorinated alkyl substances, or PFAS, chemicals. For at least these reasons, although shower water is typically not ingested, the mere fact that the heated water with harmful chemicals is contacting skin for prolonged periods of time while in the shower and steam containing these chemicals exists and are breathed in by people while showering, there is a need to treat shower water while providing for a showerhead that is both aesthetically pleasing and functionally desirable.

### SUMMARY

To protect people against pollutants in showers, the principles provided herein include a showerhead assembly inclusive of a water filter. One embodiment of a showerhead assembly may include a base member that may house a water filter that is fluidly connected to a handheld showerhead that may be magnetically coupled to the base member. The base member and handheld showerhead may be configured to enable the handheld showerhead to be rotated in an elevation direction and set to a desired elevational angle. The base member may be configured to enable the water filter to be front-loaded, thereby eliminating the need to remove the base member from a shower pipe. The handheld showerhead may also include a feature that enables a user to position a water-dissolvable treatment element, such as a skin or hair treatment element therein such that flowing water may form a solution from the treatment element.

In an alternative embodiment, the showerhead assembly may also have functionality to make the showerhead assembly easier to use and more versatile for a user. In an embodiment, the stationary showerhead may have a center portion that stores the water filter by a push-to-open/close, push-and-twist open/close, or are threaded to open/close. If a handheld showerhead is provided with the showerhead assembly, magnets may be positioned in a center region of a front face of the stationary showerhead and on a rear housing of the handheld showerhead to magnetically retain the handheld on the stationary showerhead, thereby providing for ease of use of the showerhead assembly.

One embodiment of a showerhead assembly may include a base member configured to be fluidly connected to a shower pipe, and defining a cavity in which a water filter is disposed. Magnet(s) may be positioned at a front wall opposite a wall that is proximate the shower pipe. A handheld showerhead may be fluidly connected to the base member. The handheld showerhead may include (i) a rear wall and (ii) a front face. Second magnet(s) may be positioned and arranged to be attracted to the first magnet(s). The handheld showerhead may be altered from a first elevation angle to a second elevation angle while magnetically retained by the base member. The handheld showerhead may be altered from a first elevation angle to a second elevation angle while magnetically retained by the base member.

Another embodiment of a showerhead assembly may include a stationary showerhead fluidly connected to a shower pipe, the stationary showerhead including a fluid pathway therethrough and a front face that defines a plurality of openings for water to exit therefrom, the front face defining a cavity opening and a cavity within the stationary showerhead in which a water filter is disposed, the cavity in fluid communication with the fluid pathway and the plurality of openings, the water filter arranged within the cavity such that water flowing through the cavity flows through the water filter prior to exiting from the openings of the front face of the stationary showerhead.

Methods for forming showerhead assemblies described herein may be performed to produce and/or assemble the showerhead assemblies. Moreover, kits that include the various components that form the showerhead assemblies may be constructed and distributed for consumers to install in a shower.

### BRIEF DESCRIPTION OF THE FIGURES

A more complete understanding of the method and apparatus of the present invention may be obtained by reference to the following Detailed Description when taken in conjunction with the accompanying figures wherein:

FIGS. 1A-1N are illustrations of an illustrative showerhead assembly inclusive of a base member that directly or indirectly attaches to a shower pipe, houses a water filter, and optionally includes magnets to enable a handheld showerhead to be magnetically coupled to the base member;

FIG. 2 is an illustration of a kit including components of the showerhead assembly of FIGS. 1A-1N;

FIGS. 3A-3D are illustrations of an illustrative showerhead assembly including a stationary showerhead fluidly connected to a shower pipe and including a water filter that is front-loaded via a front face of the stationary showerhead;

FIGS. 4A-4C are illustrations at different angles of an illustrative showerhead assembly inclusive of a functional stationary showerhead and a handheld showerhead disposed on a front face of the stationary showerhead;

FIGS. 4D-4I are illustrations of the illustrative showerhead assembly of FIGS. 4A-4C inclusive of the stationary showerhead and the handheld showerhead disposed on the front face of the stationary showerhead along with a wall-mountable dock inclusive of regions in which multiple user-changeable front faces of the handheld showerhead may be retained while not in use; and

FIG. 5 is an illustration of a kit of components of the showerhead assembly of FIGS. 4A-4I.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

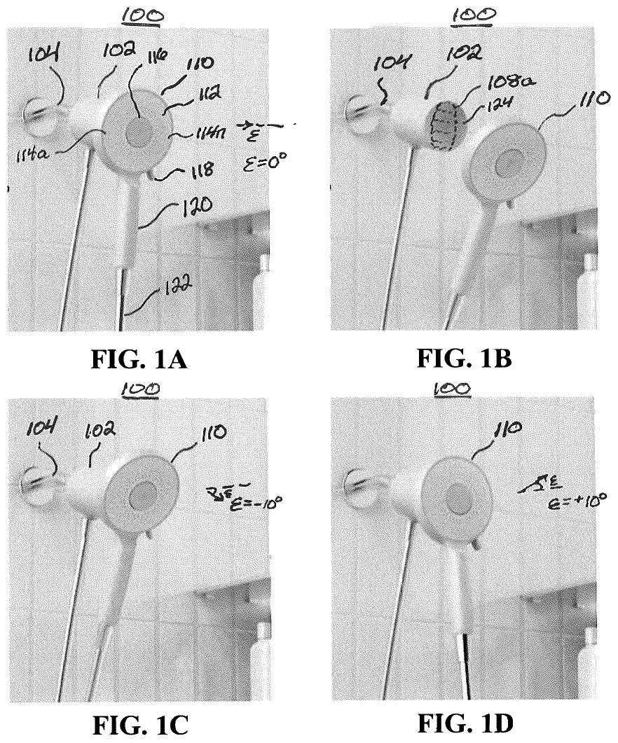

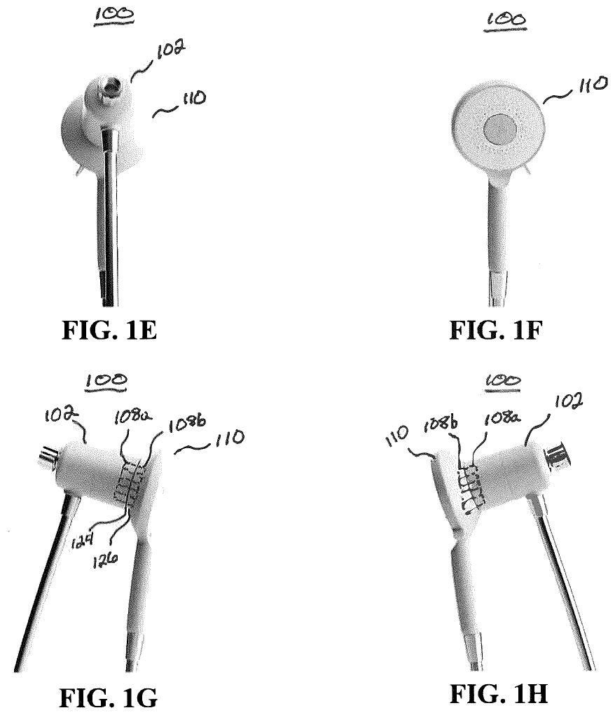

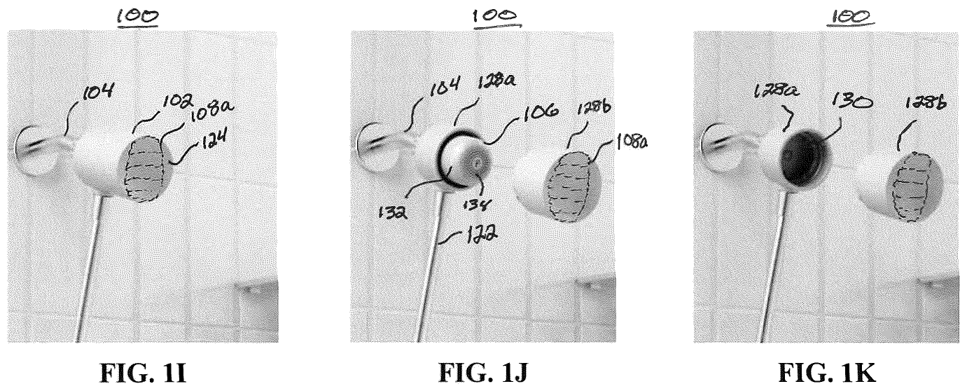

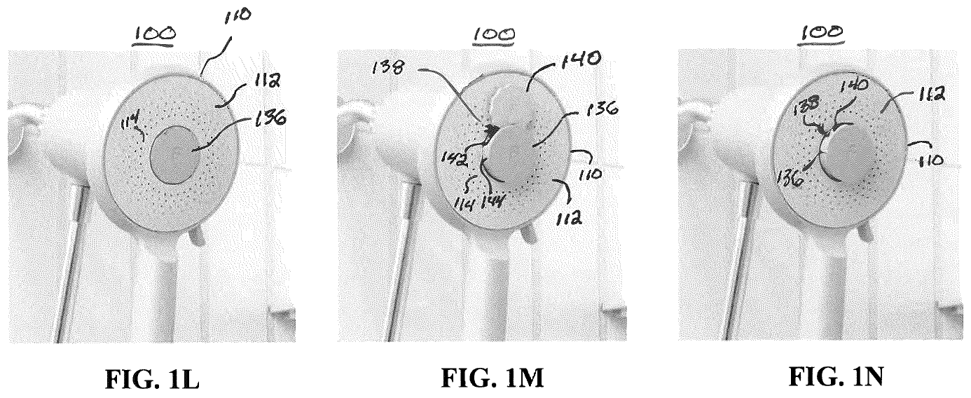

With regard to FIGS. 1A-1N, illustrations of an illustrative showerhead assembly 100 inclusive of a base member 102 that directly or indirectly attaches to a shower pipe 104, houses a water filter 106 (see FIG. 1J), and optionally includes one or more magnets 108a to enable a handheld showerhead 110 to be magnetically coupled to the base member 102 are shown. The handheld showerhead 110 may also include one or more magnets 108b (see FIGS. 1G and 1H) that have opposite polarization facing the magnets 108a, thereby causing the two sets of magnets 108a and 108b (collectively 108) to be attracted to one another. In an alternative embodiment, rather than both the base member 102 and handheld showerhead 110 having magnets 108 configured to attract to one another, one of the base member 102 or handheld showerhead 108 may have metal to which the magnets 108a or 108b are attracted, thereby retaining the handheld showerhead 110 to the base member 102, albeit with less force than the two sets of magnets 108, and enabling tip-tilt (i.e., elevation angle rotation) functionality of the handheld showerhead 110 described herein.

As shown in FIG. 1A, the base member 102 is shown to be retaining the handheld showerhead 110 using magnets 108a and 108b. A front face 112 of the handheld showerhead 110 includes multiple apertures 114a-114n (collectively 114) defined thereby to enable waterflow to exit the front face 112 of the handheld showerhead 110. In the embodiment shown, the front face 112 may be circular and the apertures may be formed in a ring surrounding a cavity access feature 116. The cavity access feature 116 may be a door or structure behind which a compartment or cavity (see FIGS. 1M and 1N) is positioned (see, for example, FIGS. 1L-1N). It should be understood that the shapes of the various features are illustrative and alternative shapes and configurations that may provide for the same or similar functionality may be utilized.

A control lever 118 may be rotated around the front face 112, and be configured to cause water pressure to increase or decrease by opening and closing a valve or other feature disposed within the handheld showerhead 110. Alternatively and/or additionally, the control lever 118 may be configured to cause the water flow to transition from a continuous stream to a pulsating stream of water. Still yet, the control lever 114 may be configured to narrow or widen the water flow from the handheld showerhead 110. It should be understood that more than one control lever or other control device (e.g., knob that is rotated) to cause one or more functions to be performed by the handheld showerhead 110 may be provided.

The handheld showerhead 110 may further include a handle 120 that a user may hold when used in the handheld showerhead 110 in a handheld manner as removed from the base member 102, as shown in FIG. 1B. The base member 102 and handheld showerhead 110 may be fluidly connected by a water conduit or hose 122 connected therebetween. As shown in FIG. 1A, an elevation angle ε is at 0° relative to an axial direction of the base member 102. As shown in FIG. 1C, the handheld showerhead 110 is at an elevation angle ε of −10°, and as shown in FIG. 1D, the handheld showerhead 110 is at an elevation angle ε of +10°. In each of the different elevation angles ε, the magnets 108a and 108b may magnetically retain the handheld showerhead 110 at the respective elevation angles ε, as adjusted or set by the user. In an embodiment, the base member 102 and/or showerhead 110 may be configured with two or more preset elevation angles ε.

With regard to FIG. 1E, a rear view of the showerhead assembly 100 is shown with the handheld showerhead 110 being positioned on the base member 102. FIG. 1F is a front view illustration of the illustrative showerhead assembly 100. With regard to FIG. 1G, a left side view of the showerhead assembly 100 shows the base member 102 supporting the handheld showerhead 110 using magnets 108a and 108b to magnetically retain the handheld showerhead 110 to the base member 102. The magnets 108a and 108b, of course, have magnetic poles that attract one another at a front wall 124 (FIG. 1B) of the base member 102 and rear wall 126 of the handheld showerhead 110. As shown in FIG. 1B, the front wall 124 of the base member 102 is curved, and in this embodiment is concave, such as a bowl shape. The rear wall 126 of the handheld showerhead 110 may be curved and be a complement shape (i.e., an inverted bowl or dome shape) of the front wall 124 such that the walls 124 and 126 are in contact with one another when magnetically held to one another. It should be understood that a variety of different shapes, such as a parabola, ellipse, or other curved shape, generally symmetrical across a horizontal plane, that accommodates an elevation angle ε to be set by a user and have the elevation angle ε of the handheld showerhead 110 relative to the base member 102 be retained by the magnets 108. In other words, the shape of the front and rear walls 124 and 126 along with the strength of the magnets 108 enable the elevation angle ε to be set by a user and retained at those angles.

FIG. 1H is a right side view of the showerhead assembly 100 showing the handheld showerhead 110 magnetically supported by the base member 102 by magnets 108. Although the showerhead 100 does not include any mechanical mechanisms beyond the magnets 108, it should be understood that mechanical mechanisms, such as clips, pins, latches, or other mechanisms to retain the handheld showerhead 110 with the base member 102 and allow for changes of the elevation angle ε to be made by a user. It should also be understood that although the configuration of the front wall 124 of the base member 102 and rear wall 126 of the handheld showerhead 110 allow for a continuous adjustment of the elevation angle ε without limitation, but alternative embodiments in which preset elevation angles may be provided.

With regard to FIG. 1I, an illustration of the base member 102 fluidly connected to the shower pipe 104 is shown. One or more magnets 108a are disposed behind the front wall 124. As shown in FIG. 1J, the base member 102 may have a rear housing 128a and front housing 128b that define a cavity 130 (FIG. 1K) into which the water filter 106 may be positioned. In an embodiment, the water filter 106 may be secured within cavity 130 such that water that enters the cavity 130 from the shower pipe is forced through the water filter 106, thereby causing the water to be filtered prior to exiting the handheld showerhead 106. The filtered water exits through the hose 122 to the handheld showerhead 110. In an embodiment, the water filter 106 may be screwed into threads within the cavity positioned against an inside wall of the rear housing 128a. Alternative configurations may be utilized to cause water to flow through the water filter 106 flowing through a fluid pathway defined within the handheld showerhead 110. As shown, the water filter 106 may include a filter housing 132 that defines openings 134 on a front side and rear side (not shown) of the filter housing 132 to enable unfiltered water to flow into and filtered water to flow out of the water filter 106.

With regard to FIGS. 1L-1N, three respective states of the handheld showerhead 110 are shown. In this embodiment, a hatch member 136 is disposed in a center location of the front face 112 of the handheld showerhead 110. The hatch member 136 may be configured to have a closed state, as shown in FIG. 1L, and an open state, as shown in FIG. 1M. In the closed state of FIG. 1L, the hatch member 136 may be flush with the front face 112 of the handheld showerhead 110 and provide for a wall of a compartment or cavity 138 therebehind. The compartment 138 may be a defined region in which one or more structural members (not shown) that are attached to the hatch member 136 to receive and retain a treatment element 140, such as a skin or hair treatment element, are located. The treatment element 140 be formulated to create a water-based solution that performs other bodily or non-bodily functions (e.g., water coloring for Halloween). The compartment 138 may be a cavity formed within the handheld showerhead 110 for retaining the treatment element 140, and may enable water flow through a fluid pathway to pass across the treatment element 140 prior to being output via the openings 114 of the front face 112 of the handheld showerhead 110. The treatment element 140 may be a solid, compressed gel, gel, liquid, or otherwise. If in a gel or liquid form, the treatment element 140 may be contained within a container or other permeable or semi-permeable component for easy transport and handling. In an embodiment, the compartment 138 may allow for liquid or powder to be directly dispensed therein.

As previously described, the treatment element 140 that is in the compartment 138 may be selectively exposed or shielded from the water flow by providing a control lever or other mechanism (e.g., rotation of the hatch member 136 from an “apply treatment” state to a “no treatment” state), thereby enabling the user to have the treatment element 140 positioned within the compartment 138, but selectively use the treatment element (e.g., when washing hair, when washing face, etc.). The treatment element 140 is shown to be a thin disc having “petals” disposed along the perimeter of the treatment element 140. In an embodiment, the compartment 138 may be configured with an internal shape that is complement of the shape of the treatment element 140, thereby limiting non-treatment elements from being inserted therein. The hatch member 136 may include a slot 142 on a sidewall 144 of the hatch member 136 through which the treatment element 140 is inserted to be stored in the compartment 138. In an embodiment, the hatch member 136 may also have a shape that matches the profile shape of the treatment element 140 by having “petals,” thereby being both ornamental and suggestive as to the purpose (i.e., to enable the treatment element 140 to be inserted therein) of the compartment behind the hatch member 136.

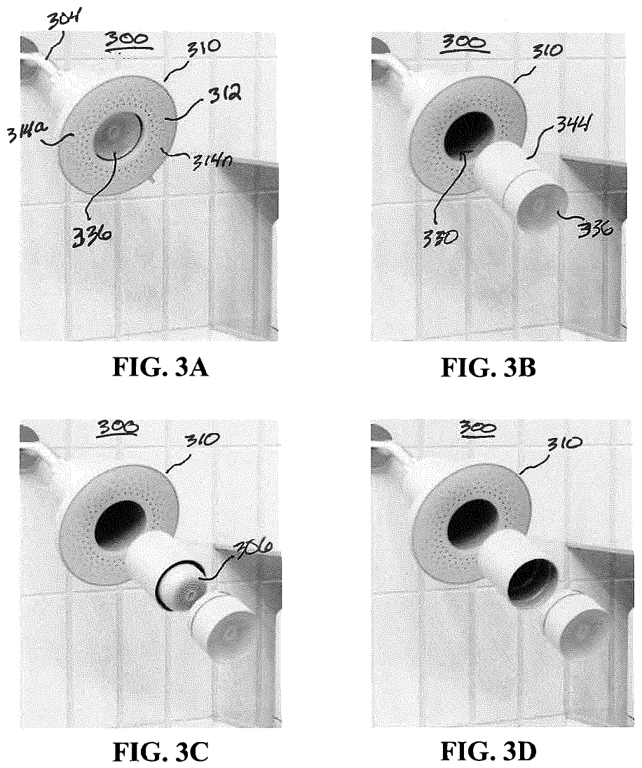

To transition the hatch member 136, a user may press the hatch member 136 to cause a push-to-open/close mechanism to be actuated. Alternatively, the hatch member 136 may have threads that allow for the hatch member 136 to be screwed in and out of the front face 112. In an embodiment, a hinge (not shown) that allows for the hatch member 136 to be rotated in and out and a latch, clasp, or other mechanism that holds the hatch member 136 into the front face 112 may be included. Because water may flow through the compartment 138, the hatch member 136, when in the closed state, is to be secure and leak-free enough to avoid unexpected opening or leaking therefrom. The hatch member 136 and handheld showerhead 110 are shown to be circular, but alternative shapes, such as square, rectangular, diamond, oval, or otherwise may be utilized. In an embodiment, the hatch member 136 may have “pedals” on the perimeter to match that of the treatment element 140. Although the embodiment presented includes a handheld showerhead 110, it should be understood that certain functions (e.g., hatch member in which a treatment element may be inserted) thereof may be incorporated into a stationary showerhead (see, for example, FIG. 3A). A stationary showerhead is configured to be pivotable in azimuth and elevation, but is not considered to be a handheld showerhead.

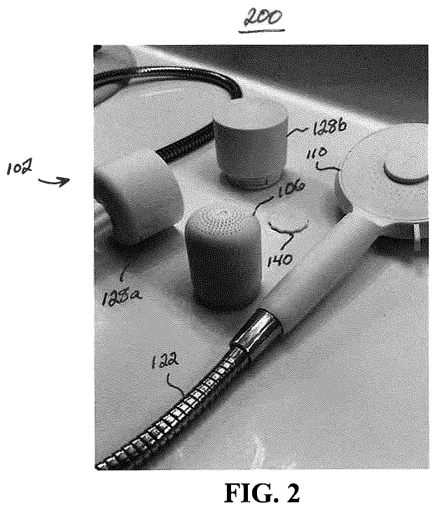

With regard to FIG. 2, an illustration of a showerhead assembly kit 200 including components of the showerhead assembly 100 of FIGS. 1A-1N is shown. The kit 200 includes the base member 102 with the rear housing 128a and front housing 128b, water filter 106, handheld showerhead 110, water hose 122, and optionally treatment element 140 (may be separate from the kit 200). It should be understood that the kit 200 may include additional and/or alternative components and with different configurations, but be configured to provide the same or similar functionality as described with regard to FIGS. 1A-1N.

With regard to FIGS. 3A-3D, illustrations of an illustrative showerhead assembly 300 including a stationary showerhead 310 fluidly connected to a shower pipe 304 and including a water filter 306 that is front-loaded via a front face 312 of the stationary showerhead 310 are shown. The stationary showerhead 302 may include a hatch member 336 that is a press-release mechanism. In a closed state, the hatch member 336 may be configured to retain the water filter 306 within a cavity 330. The water filter 306 may be positioned within a water filter retention housing 342 into which the hatch member 336 connects. The filter retention housing 342 may be configured to secure into the showerhead 310 and have water from the shower pipe 304 pass therethrough and through the water filter 306 prior to be output via openings 314a-314n (collectively 314) defined by the front face 312 of the stationary showerhead 310. In an embodiment, the filter retention housing 344 may have threads or any other connection feature(s) that are reciprocal to connection feature(s) within or defined by the stationary showerhead 310 so as to secure the filter retention housing 344 within the cavity 330 and force the water through the water filter 306. In an embodiment, the hatch member 336 may be releasably connected to the retention housing 344 or the retention housing 344 may be releasably connected to the stationary showerhead 310. In either case, by having the water filter 306 be accessible via a front face 312 of the stationary showerhead 310, a user may be able to replace the water filter 306 in an easy and safe manner. In an alternative embodiment, the water filter 306 resides behind the hatch member 336 without the use of a retention housing 344. In such an embodiment, the water filter 306 may be configured to attach to the inside of the cavity 330 such that water flows through the water filter 306.

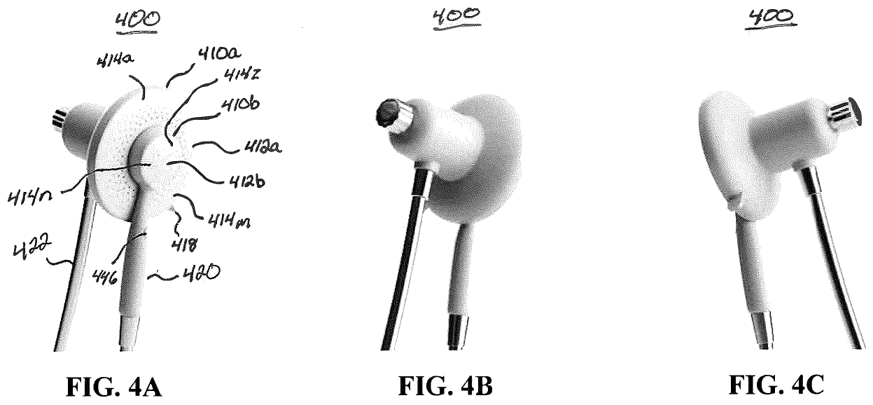

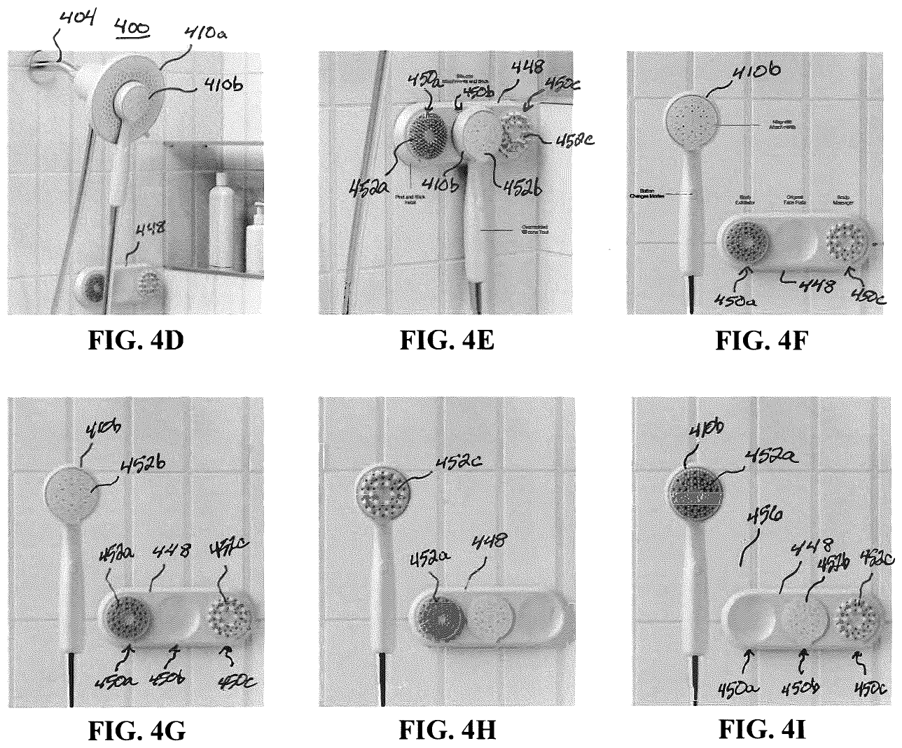

With regard to FIGS. 4A-4C, illustrations at different angles of an illustrative showerhead assembly 400 inclusive of a functional stationary showerhead 410a and a handheld showerhead 410b (collectively 410) disposed on a front face 412a of the stationary showerhead 410a are shown. The handheld showerhead 410b may be removably positioned on the front face 412a of the stationary showerhead 410a with a front face 412b of the handheld showerhead 410b facing in the same direction as the front face 412a of the stationary showerhead 410a. The front face 412a of the stationary showerhead 410a may define a plurality of openings 414a-414m through which filtered water may be output. Similarly, the front face 412b of the handheld showerhead 414b may define a plurality of openings 414n-414z through which filtered water may be output. In an embodiment, if the stationary showerhead 410a is operating to output water, then water may be prevented from flowing to the handheld showerhead 410b, and vice versa. Alternatively, both showerheads 410a and 410b may be configured to output filtered water simultaneously.

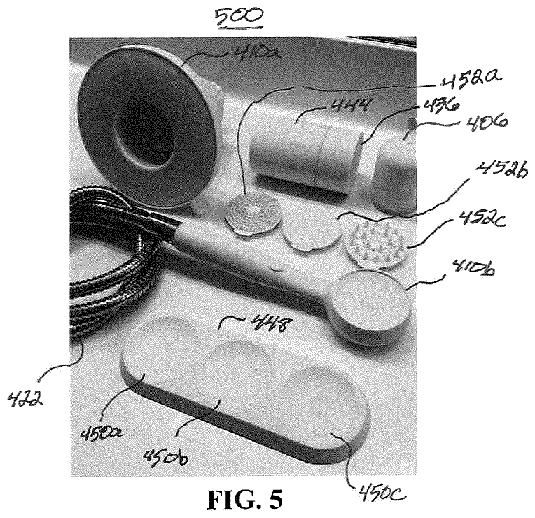

A cavity access feature (disposed behind the handheld showerhead 410b) 436 (see FIG. 5) may enable a user to access the cavity 430 in which a water filter 406 (see FIG. 5) may be retained, such as shown in FIGS. 3A-3D. The stationary showerhead 410a and handheld showerhead 410b may be fluidly connected to one another via a flexible water hose 422. In an embodiment, the handheld showerhead 410b may have magnets (see, for example, 108b of FIG. 1G) disposed at a rear wall (not shown) thereof to be attracted to magnets (see, for example, 108a of FIG. 1G) of a front wall (not shown) of the cavity access feature 436 (see, for example, FIG. 1G). The stationary showerhead 410a may include a control member 418 that may be actuated (e.g., rotated) to cause a change in the water output from the stationary showerhead 410a. The handheld showerhead 410b may have a handle 420 that a user may hold when the handheld showerhead 410b is used off of the stationary showerhead 410a by a user. In an embodiment, a control feature 446 (e.g., push button, knob, etc.) disposed on the handle 420 may be used to control function of the handheld showerhead 410b whether water is output, change mode (e.g., pulsation speed, pressure, and/or other mode) of the handheld showerhead 410b, or cause other functions to occur. In an embodiment, the control feature 446 may be alternately located (e.g., on the stationary showerhead 410a). It should be understood that non-magnetic versions of supporting the handheld showerhead 410b by the stationary showerhead 410a may be utilized by using retention features on the front face 412a of the stationary showerhead 410a and/or other features that retains the handheld showerhead 410b to the stationary showerhead 410a. FIGS. 4B and 4C are left rear and right side perspective views of the showerhead assembly 400 of FIG. 4A.

With regard to FIGS. 4D-4I, illustrations of an illustrative showerhead assembly of FIGS. 4A-4C inclusive of a functional stationary showerhead 410a and the handheld showerhead 410b disposed on the front face 412a of the stationary showerhead 410a along with a wall-mountable dock 448 defining showerhead face storage regions 450a-450c (collectively 450) in which multiple user-changeable front faces 452a-452c (collectively 452) of the handheld showerhead 410b may be retained while not in use are shown. The stationary showerhead 410a may be connected to a shower pipe 404 directly or indirectly either using an adapter or connector. The user-changeable front faces 452 may each have a different function. For example, front face 452a may be configured to be a body exfoliator, front face 452b may be a plain face to a showerhead without specific functions for use on a human or animal (e.g. dog) body, and front face 452c may be configured to be a scalp massager. Other configurations and functions are possible. The materials of each of the front faces 450 may be plastic, silicone, metal, rubber, and/or any other material that is able to be used in wet and hot conditions without deformation or degradation over a short period of time (e.g., within a few years). In an alternative embodiment, a showerhead or another adapter may provide for female or male sensual pleasure.

As shown in FIG. 4E, an illustration of the dock 448 that is storing front faces 452a and 452c while supporting the handheld showerhead 410b on which the front face 452b is retained. In an embodiment, the front faces 452 may include at least one magnet that is attracted to a magnet that is positioned on the handheld showerhead 410b disposed behind the front face 452b mounted thereon. In an embodiment, the front faces may be configured to engage with one or more mechanical features in addition to or in lieu of magnets. For example, the handheld showerhead 410b may have threads into which the front faces 452 are screwed to be secured to the handheld showerhead 410b. Alternatively, features that enable the front faces 452 to snap, clamp, or otherwise be removably connected to the handheld showerhead 410b may be utilized. The regions 450 may be shaped to enable a rear wall of the handheld showerhead 410b that may have a reciprocal shape (or at least a shape that is compatible) to be engaged and secured thereto via magnets or other securing feature(s).

As shown in FIGS. 4F and 4G, the front face 452b is attached to the handheld showerhead 410b while the front faces 452a and 452c are positioned on the dock 448 that is mounted (e.g., adhered) to the wall 454. In FIG. 4H, the front face 452b is positioned on the dock 448 in front face storage region 450b and front face 452a is positioned onto the handheld showerhead 410b (e.g., magnetically adhered, snapped in, etc.). In FIG. 4I, the front face 452a is mounted to the handheld showerhead 410b and front faces 452b and 452c are positioned on the dock in storage regions 450b and 450c. It should be understood that the positions of each of the front faces 452 may be configured for specific storage regions 450 or be configured to be positioned on a specific one of the storage regions 450.

With regard to FIG. 5, an illustration of an kit 500 of components of the showerhead assembly of FIGS. 4A-4I are shown. The kit 500 may include the stationary showerhead 410a configured to be connected to the shower pipe 404 (see FIG. 4D) and support the handheld showerhead 410b utilizing magnets (see, for example, FIG. 1G) to magnetically retain the handheld showerhead 410b to the stationary showerhead 410a. In an embodiment, a hatch member 436 that is configured to connect to a filter retention member 444 that collectively forms a cavity in which the water filter 406 may be disposed may also be part of the kit 500. As previously described, the filter retention member 444 and hatch member 436 may enable water to flow therethrough so as to be filtered by the water filter 406 prior to being output by the showerheads 410. In an embodiment, different front faces 452a, 452b, and 452c may be configured to be mountable to the handheld showerhead 410b and to the wall-mountable dock 448 that may be mounted to a wall utilizing an adhesive or any other attachment mechanism. The wall-mountable dock 448 makes it easier for a user to store the different front faces of the handheld showerhead 410b as well as supporting the handheld showerhead 410b in one of the showerhead face storage regions 450a-450c when the showerhead is being used or not being used. It should be understood that additional and/or alternative components and shapes of the components may be utilized to provide the same or similar functionality.

A showerhead assembly may include a base member configured to be fluidly connected to a shower pipe, and defining a cavity in which a water filter is disposed. Magnet(s) may be positioned at a front wall opposite a wall that is proximate the shower pipe. A handheld showerhead may be fluidly connected to the base member. The handheld showerhead may include (i) a rear wall and (ii) a front face. Second magnet(s) may be positioned and arranged to be attracted to the first magnet(s). The handheld showerhead may be altered from a first elevation angle to a second elevation angle while magnetically retained by the base member. The handheld showerhead may be altered from a first elevation angle to a second elevation angle while magnetically retained by the base member.

The front wall of the base member may have a curved surface and the rear wall of the handheld showerhead may have a complementary curved surface that enables rotation of the elevation angle of the handheld showerhead. The curved surface of the front wall of the base member may include a concave shape and the rear wall of the handheld showerhead may include a convex shape that extends into the concave shape such that the front and rear walls are in contact with one another and support setting the elevation angle of the handheld showerhead.

The front face of the handheld showerhead may include a cavity access feature that enables a user to gain access to a cavity in which a skin treatment element is able to be positioned when the cavity access feature is in an open state and retained in the cavity when the cavity access feature is in a closed state. The showerhead assembly may further include a control member that causes water to be output via the openings of the front face of the handheld showerhead to pass across the skin treatment element when in a first state and prevent the water to be output via the openings of the front face of the handheld showerhead when the control member is in a second state. The control member may be a lever positioned along a side surface of the handheld showerhead. The cavity access feature may be configured to be pressed to transition from the closed state to the open state, and re-pressed to transition from the open state to the closed state. The skin treatment element may a water-dissolvable element configured to be inserted into the cavity when the cavity access feature is in the open state. The cavity access feature may include a slot in a side wall that is accessible to insert the skin treatment element when the cavity access feature is in the open state. The base member may include a housing including a rear member and a front member releasably attached to the rear member and that define the cavity in which the water filter is disposed.

Another embodiment of a showerhead assembly may include a stationary showerhead fluidly connected to a shower pipe, the stationary showerhead including a fluid pathway therethrough and a front face that defines a plurality of openings for water to exit therefrom, the front face defining a cavity opening and a cavity within the stationary showerhead in which a water filter is disposed, the cavity in fluid communication with the fluid pathway and the plurality of openings, the water filter arranged within the cavity such that water flowing through the cavity flows through the water filter prior to exiting from the openings of the front face of the stationary showerhead.

The showerhead assembly may further include a hatch member disposed at the cavity opening to enable a user to insert and remove the water filter therethrough. The hatch member may be activated to open by pressing the hatch member. The showerhead assembly may further include a retention housing to which the hatch member connects, thereby forming a housing in which the water filter is positioned when inserted into the stationary showerhead.

A handheld showerhead may further be fluidly connected to the stationary showerhead, where the handheld showerhead includes at least one first magnet disposed on a rear wall of the handheld showerhead, and configured to be magnetically coupled to at least one second magnet disposed at the front face of the stationary showerhead when the rear wall of the handheld showerhead is positioned at a location of the front face that includes at least one second magnet. The location of the front face includes a hatch member having a first curved shape. The rear wall of the handheld showerhead defines a second, complementary curved shape from the first curved shape, and the handheld showerhead may be configured to be altered in elevation while magnetically coupled with the stationary showerhead.

The showerhead assembly may further be configured to include a wall-mountable dock defining a plurality of showerhead face storage regions, and multiple user-changeable front faces may be configured (i) to be positioned on the handheld showerhead and (ii) disposed on the showerhead face storage regions, thereby enabling storage of one or more user-changeable front faces on the wall-mountable dock when not positioned on the handheld showerhead.

Each of the user-changeable front faces may include at least one magnet configured to magnetically couple the user-changeable front faces to the handheld showerhead. The handheld showerhead may further be configured to be positioned in at least one of the showerhead face storage regions with a rear wall of the handheld showerhead such that a front face of the handheld showerhead is facing away from the wall-mountable dock.

Methods for forming showerhead assemblies described herein may be performed to produce and/or assemble the showerhead assemblies. Moreover, kits that include the various components that form the showerhead assemblies may be constructed and distributed for consumers to install in a shower.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A showerhead assembly, comprising:
a base member configured to be directly or indirectly connected to a shower pipe, the base member defining a cavity in which a water filter is disposed in at least one first magnet is positioned at a front wall opposite a wall that is proximate the shower pipe; and
a handheld showerhead fluidly connected to the base member, the handheld showerhead including (i) a rear wall and (ii) a front face that defines a plurality of openings through which water exits the handheld showerhead, the rear wall and front face defining a cavity in which at least one second magnet is positioned and is arranged to be attracted to the at least one first magnet when the rear wall of the handheld showerhead is positioned against the front wall of the base member such that the handheld showerhead is magnetically retained by the base member, the front wall of the base member and the rear wall of the handheld showerhead being respectively configured to enable the handheld showerhead to be altered from a first elevation angle to a second elevation angle while magnetically retained by the base member.

2. The showerhead assembly according to claim 1, wherein the front wall of the base member has a curved surface and the rear wall of the handheld showerhead has a complementary curved surface that enables rotation of the elevation angle of the handheld showerhead.

3. The showerhead assembly according to claim 1, wherein the curved surface of the front wall of the base member includes a concave shape and the rear wall of the handheld showerhead includes a convex shape that extends into the concave shape such that the front and rear walls are in contact with one another and support setting the elevation angle of the handheld showerhead.

4. The showerhead assembly according to claim 1, wherein the front face of the handheld showerhead includes a cavity access feature that enables a user to gain access to a cavity in which a skin treatment element is able to be positioned when the cavity access feature is in an open state and retained in the cavity when the cavity access feature is in a closed state.

5. The showerhead assembly according to claim 4, further comprising a control member that causes water to be output via the openings of the front face of the handheld showerhead to pass across the skin treatment element when in a first state and prevent the water to be output via the openings of the front face of the handheld showerhead when the control member is in a second state.

6. The showerhead assembly according to claim 5, wherein the control member is a lever positioned along a side surface of the handheld showerhead.

7. The showerhead assembly according to claim 4, wherein the cavity access feature is configured to be pressed to transition from the closed state to the open state, and re-pressed to transition from the open state to the closed state.

8. The showerhead assembly according to claim 4, wherein the skin treatment element is a water-dissolvable element configured to be inserted into the cavity when the cavity access feature is in the open state.

9. The showerhead assembly according to claim 8, wherein the cavity access feature includes a slot in a side wall that is accessible to insert the skin treatment element when the cavity access feature is in the open state.

10. The showerhead assembly according to claim 1, wherein the base member includes a housing including a rear member and a front member that is releasably attached to the rear member, the rear and front members defining the cavity in which the water filter is disposed.

11. A showerhead assembly, comprising:
a stationary showerhead fluidly connected to a shower pipe, the stationary showerhead including a fluid pathway therethrough and a front face that defines a plurality of openings for water to exit therefrom, the front face defining a cavity opening and a cavity within the stationary showerhead in which a water filter is disposed, the cavity in fluid communication with the fluid pathway and the plurality of openings, the water filter arranged within the cavity such that water flowing through the cavity flows through the water filter prior to exiting from the openings of the front face of the stationary showerhead.

12. The showerhead assembly according to claim 11, wherein the showerhead assembly further comprises a hatch member disposed at the cavity opening to enable a user to insert and remove the water filter therethrough.

13. The showerhead assembly according to claim 12, wherein the hatch member is activated to open by pressing the hatch member.

14. The showerhead assembly according to claim 12, further comprising a retention housing to which the hatch member connects, thereby forming a housing in which the water filter is positioned when inserted into the stationary showerhead.

15. The showerhead assembly according to claim 11, further comprising a handheld showerhead fluidly connected to the stationary showerhead, the handheld showerhead including at least one first magnet disposed on a rear wall of the handheld showerhead, and configured to be magnetically coupled to at least one second magnet disposed at the front face of the stationary showerhead when the rear wall of the handheld showerhead is positioned at a location of the front face that includes at least one second magnet.

16. The showerhead assembly according to claim 15, wherein the location of the front face includes a hatch member having a first curved shape, and wherein the rear wall of the handheld showerhead defines a second, complementary curved shape from the first curved shape, and wherein the handheld showerhead is configured to be altered in elevation while magnetically coupled with the stationary showerhead.

17. The showerhead assembly according to claim 15, further comprising:
a wall-mountable dock defining a plurality of showerhead face storage regions; and
a plurality of user-changeable front faces configured (i) to be positioned on the handheld showerhead and (ii) disposed on the showerhead face storage regions, thereby enabling storage of one or more user-changeable front faces on the wall-mountable dock when not positioned on the handheld showerhead.

18. The showerhead assembly according to claim 17, wherein each of the user-changeable front faces includes at least one magnet configured to magnetically couple the user-changeable front faces to the handheld showerhead.

19. The showerhead assembly according to claim 17, wherein the handheld showerhead is configured to be positioned in at least one of the showerhead face storage regions with a rear wall of the handheld showerhead such that a front face of the handheld showerhead is facing away from the wall-mountable dock.

20. A method of manufacturing a showerhead assembly, comprising:
forming a base member configured to be directly or indirectly connected to a shower pipe, the base member defining a cavity in which a water filter is disposed in at least one first magnet is positioned at a front wall opposite a wall that is proximate the shower pipe; and
forming a handheld showerhead in fluid communication with the base member, a handheld showerhead including a rear wall and a front face that defines a plurality of openings through which water exits the handheld showerhead, the rear wall in front face defining a cavity in which at least one second magnet is positioned and is arranged to be attracted to the at least one first magnet when the rear wall of the handheld showerhead is positioned against the front wall of the base member, a handheld showerhead is magnetically retained thereby, the front wall of the base member in the rear wall of the handheld showerhead being respectively configured to enable the handheld showerhead to be altered from a first elevation angle to a second elevation angle while magnetically retained by the base member.

21. A method of manufacturing a showerhead assembly, comprising:
forming a stationary showerhead fluidly connected to a shower pipe, the stationary showerhead including a fluid pathway therethrough and a front face that defines a plurality of openings for water to exit therefrom, the front face defining a cavity opening and a cavity within the stationary showerhead in which a water filter is disposed, the cavity in fluid communication with the fluid pathway and the plurality of openings, the water filter arranged within the cavity such that water flowing through the cavity flows through the water filter prior to exiting from the openings of the front face of the stationary showerhead.
